(19) United States
(12) Patent Application Publication
(10) Pub. No.: US 2025/0086628 A1
(43) Pub. Date: Mar. 13, 2025

(54) SYSTEM AND METHOD FOR CLASSIFYING TRANSACTION DATA

(71) Applicant: TAXHUB, INC., Las Vegas, NV (US)

(72) Inventor: George R Kent Birrell, Salt Lake City, UT (US)

(21) Appl. No.: 18/525,425

(22) Filed: Nov. 30, 2023

Related U.S. Application Data
(60) Provisional application No. 63/537,096, filed on Sep. 7, 2023.

(51) Int. Cl. G06Q 20/40; G06Q 20/38

(52) U.S. Cl. CPC G06Q 20/401; G06Q 20/3821; G06Q 2220/00

(57) ABSTRACT

A computer-implemented method includes retrieving payment transaction data from a banking transaction database, wherein the payment transaction data comprises a plurality of payment transactions, utilizing an AI processor to categorize each payment transaction of the plurality of payment transactions into a category, and utilizing the AI processor to assign a confidence level to each payment transaction. The confidence level is at or between zero percent and one hundred percent.

### CROSS-REFERENCE TO RELATED APPLICATIONS

This application claims the benefit of U.S. Provisional Application No. 63/537,096, filed on Sep. 7, 2023, which is incorporated by reference herein in its entirety.

### FIELD

This disclosure relates generally to a system and method for classifying transaction data. More particularly, embodiments of the invention relate to a method or system that utilizes an artificial intelligence (AI) to classify transaction data and give a confidence level for the transaction classification. Embodiments of the invention relate to a system and method for obtaining bank transaction data using AI generated expense classification suggestions that are given confidence levels based on feedback and machine learning algorithms as well as user inputted validation history. Embodiments of the invention relate to systems and methods for classification of bank transaction data with AI generated confidence levels. In some implementations, the classification is related to tax form classification (e.g., those found on a Schedule C, 1120S, 1065, or 1120 tax form). In other implementations, the classification is related to accounting documents (e.g., financial statements in conformity with Generally Accepted Accounting Principles (GAAP)).

### BACKGROUND

Recent years have seen significant improvements in the utilization of AI to harvest and analyze data. For example, using AI interfaces allows for a dramatic reduction in human resources for certain tasks through a functional algorithm. Conventional systems may have certain limitations in their ability to accurately categorize data and may need independent verification and validation by a trained professional. Although conventional systems can do some limited steps in trained algorithms, they cannot yet accomplish what is set forth herein with regard to systems and methods for classifying transaction data and assigning confidence levels.

Conventional systems have shortcomings in their ability to render accurate categorization and with feedback given to the system. Embodiments herein overcome shortcomings in classification and with feedback of algorithms to more accurately classify data and improve over time.

The subject matter of the present application has been developed in response to the present state of the art, and in particular, in response to the problems and disadvantages associated with conventional systems that have not yet been fully solved by currently available techniques. Accordingly, the subject matter of the present application has been developed to provide embodiments of a system and method that overcome at least some of the shortcomings of prior art techniques.

### SUMMARY

Disclosed herein is a computer-implemented method. The computer-implemented method includes retrieving payment transaction data from a banking transaction database, wherein the payment transaction data comprises a plurality of payment transactions, utilizing an AI processor to categorize each payment transaction of the plurality of payment transactions into a category, and utilizing the AI processor to assign a confidence level to each payment transaction. The confidence level is at or between zero percent and one hundred percent. The preceding subject matter of this paragraph characterizes example 1 of the present disclosure.

The computer-implemented method further includes requesting a validation from a user to validate the category of at least one transaction. The preceding subject matter of this paragraph characterizes example 2 of the present disclosure, wherein example 2 also includes the subject matter according to example 1, above.

The computer-implemented method further includes utilizing validation data to update a confidence level algorithm utilized by the AI processor. The preceding subject matter of this paragraph characterizes example 3 of the present disclosure, wherein example 3 also includes the subject matter according to any one of examples 1-2, above.

The computer-implemented method further includes requesting a validation from a user to validate the category of each transaction with a confidence level below a predetermined threshold. The preceding subject matter of this paragraph characterizes example 4 of the present disclosure, wherein example 4 also includes the subject matter according to any one of examples 1-3, above.

The computer-implemented method further includes outputting payment transactions segregated into categories in an output document based on the validation from the user. The preceding subject matter of this paragraph characterizes example 5 of the present disclosure, wherein example 5 also includes the subject matter according to any one of examples 1-4, above.

The computer-implemented method further includes receiving banking access credentials and logging into the banking transaction database. The preceding subject matter of this paragraph characterizes example 6 of the present disclosure, wherein example 6 also includes the subject matter according to any one of examples 1-5, above.

The computer-implemented method further includes utilizing a categorization algorithm to categorize the transaction, wherein the categorization algorithm utilizes one or more inputs including description of the transaction, time of the transaction, monetary amount of the transaction, location of the transaction, or vendor of the transaction. The preceding subject matter of this paragraph characterizes example 7 of the present disclosure, wherein example 7 also includes the subject matter according to any one of examples 1-6, above.

Disclosed herein is a computer system. The computer system includes one or more processors and memory including instructions which, when accessed by the one or more processors, cause the one or more processors to retrieve payment transaction data from a banking transaction database, wherein the payment transaction data comprises a plurality of payment transactions. The memory includes further instructions which cause the one or more processors to utilize an AI processor to categorize each payment transaction of the plurality of payment transactions into a category. The memory includes further instructions which cause the one or more processors to utilize an AI processor to assign a confidence level to each payment transaction, wherein the confidence level is at or between zero percent and one hundred percent. The preceding subject matter of this paragraph characterizes example 8 of the present disclosure.

The memory includes further instructions which cause the one or more processors to request a validation from a user to validate the category of at least one transaction. The preceding subject matter of this paragraph characterizes example 9 of the present disclosure, wherein example 9 also includes the subject matter according to any one of examples 1-8, above.

The memory includes further instructions which cause the one or more processors to utilize validation data to update a confidence level algorithm utilized by the AI processor. The preceding subject matter of this paragraph characterizes example 10 of the present disclosure, wherein example 10 also includes the subject matter according to any one of examples 8-9, above.

The memory includes further instructions which cause the one or more processors to request a validation from a user to validate the category of each transaction with a confidence level below a predetermined threshold. The preceding subject matter of this paragraph characterizes example 11 of the present disclosure, wherein example 11 also includes the subject matter according to any one of examples 8-10, above.

The memory includes further instructions which cause the one or more processors to output payment transactions segregated into categories in an output document based on the validation from the user. The preceding subject matter of this paragraph characterizes example 12 of the present disclosure, wherein example 12 also includes the subject matter according to any one of examples 8-11, above.

The memory includes further instructions which cause the one or more processors to receive banking access credentials and logging into the banking transaction database. The preceding subject matter of this paragraph characterizes example 13 of the present disclosure, wherein example 13 also includes the subject matter according to any one of examples 8-12, above.

The memory includes further instructions which cause the one or more processors to utilize a categorization algorithm to categorize the transaction, wherein the categorization algorithm utilizes one or more inputs including description of the transaction, time of the transaction, monetary amount of the transaction, location of the transaction, or vendor of the transaction. The preceding subject matter of this paragraph characterizes example 14 of the present disclosure, wherein example 14 also includes the subject matter according to any one of examples 8-13, above.

Disclosed herein is a computer system. The computer system includes a core engine comprising one or more processors and configured to retrieve payment transaction data from a banking transaction database, wherein the payment transaction data comprises a plurality of payment transactions. The computer system includes a categorization engine comprising one or more processors and configured utilize an AI processor to categorize each payment transaction of the plurality of payment transactions into a category. The computer system includes a confidence level engine comprising one or more processors and configured to utilize an AI processor to assign a confidence level to each payment transaction, wherein the confidence level is at or between zero percent and one hundred percent. The preceding subject matter of this paragraph characterizes example 15 of the present disclosure.

The computer system includes a validation engine comprising one or more processors and configured to request a validation from a user to validate the category of at least one transaction. The preceding subject matter of this paragraph characterizes example 16 of the present disclosure, wherein example 16 also includes the subject matter according to example 15, above.

The validation engine is configured to utilize validation data to update a confidence level algorithm utilized by the AI processor. The preceding subject matter of this paragraph characterizes example 17 of the present disclosure, wherein example 17 also includes the subject matter according to any one of examples 15-16, above.

The computer system includes a validation engine comprising one or more processors and configured to request a validation from a user to validate the category of each transaction with a confidence level below a predetermined threshold. The preceding subject matter of this paragraph characterizes example 18 of the present disclosure, wherein example 18 also includes the subject matter according to any one of examples 15-17, above.

The core engine is configured to output payment transactions segregated into categories in various forms of income statements based on the validation from the user (such as tax forms described herein or general financial statements as described herein. The preceding subject matter of this paragraph characterizes example 19 of the present disclosure, wherein example 19 also includes the subject matter according to any one of examples 15-18, above.

The core engine is configured to receive banking access credentials and log into the banking transaction database. The preceding subject matter of this paragraph characterizes example 20 of the present disclosure, wherein example 20 also includes the subject matter according to any one of examples 15-19, above.

Other aspects and advantages of embodiments of the present invention will become apparent from the following detailed description, taken in conjunction with the accompanying drawings, illustrated by way of example of the principles of the invention.

### BRIEF DESCRIPTION OF DRAWINGS

In order that the advantages of the subject matter may be more readily understood, a more particular description of the subject matter briefly described above will be rendered by reference to specific embodiments that are illustrated in the appended drawings. Understanding that these drawings depict only typical embodiments of the subject matter and are not therefore to be considered limiting of its scope, the subject matter will be described and explained with additional specificity and detail through the use of the drawings.

FIG. 1 depicts a schematic overall diagram of a system according to one or more embodiments of the present disclosure.

FIG. 2 depicts a schematic diagram of a computing system according to one or more embodiments of the present disclosure.

FIG. 3 depicts a schematic diagram of a categorization system, according to one or more embodiments of the invention.

FIG. 4 depicts a schematic flow diagram of a categorization method, according to one or more embodiments of the invention.

FIG. 5 depicts a schematic flow diagram of a categorization method, according to one or more embodiments of the invention.

Throughout the description, similar reference numbers may be used to identify similar elements. The following list is an example of the reference numbers used in the accompanying drawings:

| Reference # | Designation |
|---|---|
| 12 | Computer System |
| 14 | Processing Unit |
| 16 | Bus |
| 18 | I/O Interface(s) |
| 20 | Network Adaptor(s) |
| 22 | Memory |
| 24 | RAM |
| 26 | Cache Memory |
| 28 | Storage Media |
| 60 | Network |
| 110 | Control System |
| 150 | AI Processor |
| 160 | Banking Database |
| 170 | Server Data |
| 190 | Validation User Interface |
| 200 | Core Engine |
| 210 | Graphical User Interface |
| 220 | Inputs |
| 225 | Storage |
| 235 | Confidence Level Engine |
| 240 | Categorization Engine |
| 252 | Categorization Algorithm |
| 254 | Confidence Level Algorithm |
| 270 | Output Database |
| 272 | Editable Table |
| 274 | Income Statement |
| 276 | Balance Sheet |
| 285 | Validation Engine |

Throughout this application, similar designations or vocabulary may be used to identify similar elements, although the breadth of this disclosure should be understood to incorporate any alternatives and variations referenced within the specification (including the claims) and the accompanying drawings.

### DETAILED DESCRIPTION

It will be readily understood that the components of the embodiments as generally described herein and illustrated in the appended figures could be arranged and designed in a wide variety of different configurations. Thus, the following more detailed description of various embodiments, as represented in the figures, is not intended to limit the scope of the present disclosure but is merely representative of various embodiments. While the various aspects of the embodiments are presented in drawings, the drawings are not necessarily drawn to scale unless specifically indicated.

The present invention may be embodied in other specific forms without departing from its spirit or essential characteristics. The described embodiments are to be considered in all respects only as illustrative and not restrictive. The scope of the invention is, therefore, indicated by the appended claims rather than by this detailed description. All changes which come within the meaning and range of equivalency of the claims are to be embraced within their scope.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussions of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize, in light of the description herein, that the invention can be practiced without one or more of the specific features or advantages of a particular embodiment. In other instances, additional features and advantages may be recognized in certain embodiments that may not be present in all embodiments of the invention.

Reference throughout this specification to “one embodiment,” “an embodiment,” or similar language means that a particular feature, structure, or characteristic described in connection with the indicated embodiment is included in at least one embodiment of the present invention. Thus, the phrases “in one embodiment,” “in an embodiment,” and similar language throughout this specification may, but do not necessarily, all refer to the same embodiment.

While many embodiments are described herein, at least some of the described embodiments describe a computer-implemented method.

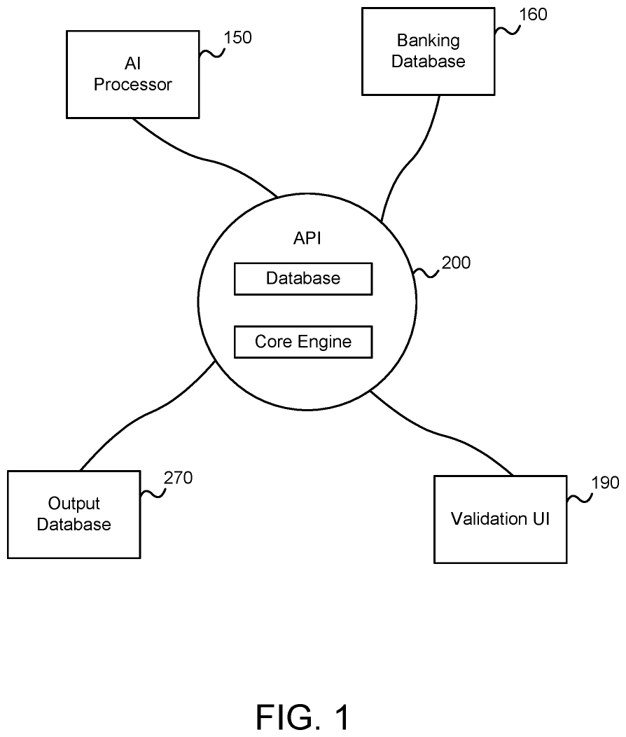

FIG. 1 depicts a schematic overall diagram of a system according to one or more embodiments of the present disclosure. Although the system is shown and described with certain components and functionality, other embodiments of the system may include fewer or more components to implement less or more functionality.

Referring to FIG. 1, a generalized understanding of embodiments of the invention is possible with respect to the overall system described with FIG. 1. The system includes a core engine 200. The core engine 200 directly or via an API layer (application programming interface) communicates with various other components that may be internal or external with the core engine 200. The core engine 200 an engine that is configured to aggregate and analyze information and data. The core engine 200 may be partially computer software based to carry out the functions that are set forth herein.

A component that the core engine 200 communicates with includes, in some embodiments, a banking database 160. The banking database 160 may be located in a separate system that communicates with the core engine 200. In some implementations, the banking database 160 is merely an online portal of a user's bank account. The online portal may have individualized data transactions related to a user's particular bank account. In some implementations, a user is prompted by the core engine 200 to input bank login information. Such bank login information may be used by the system to log in to a bank's system or a separate platform. The core engine 200 can be limited in what data and what transactions are accessed. Such inputs that might be used to tailor the access that is granted to the core engine 200 may include, but is not limited to, a date range.

The core engine 200 is configured to allow a user to input bank information and grant access to the banking database by the core engine 200. While described herein as an online banking platform, a banking database 160 may, in other implementations, be another type of database including a generalized accounting database. Monetary transaction data may be already downloaded or tabulated in such a separate database. While described as a banking database, the database may be merely a list of monetary transactions that are capable of being classified into different categories or classifications for tax purposes or accounting purposes.

The core engine 200, in some embodiments, is configured to retrieve data from the banking database 160. The core engine 200 may be configured to retrieve whatever data is necessary for the other components to function as described herein. The data retrieved includes, at a minimum, the monetary value of the transaction and some limited information relating to the transaction. The information relating to the transaction may include the vendor information, the time of the transaction, the location of the transaction, or information about surrounding transactions near in time or location to the transaction at issue. As an example, and to better understand, a transaction close in time may affect how a particular transaction is classified. Multiple data points are collected. The data points may be collected and stored in a separate database on an internal server or associated with core engine (see FIG. 1) or on another external database such as the output database 270. The data may be stored in a database format file or something similar.

In some embodiments, the core engine 200 is configured to communicate with an Artificial Intelligence (AI) platform or AI processor 150. In some embodiments, the information communicated with the AI processor 150 includes all the data retrieved from the banking database 160. In some embodiments, the information communicated with the AI processor 150 includes only some of the data retrieved from the banking database 160.

In some embodiments, the core engine 200 is configured to automatically prompt the AI processor 150 with a preconfigured prompt to have the AI processor 150 classify or categorize each transaction retrieved from the banking database 160. This may be from the database format file or another file that comprises the transactions to be analyzed.

The categorization or classification may be related to (1) a tax classification related to standard tax documentation or (2) a general accounting classification based on GAAP guidelines or another accounting guideline, or a (3) a generalized budgeting classification. The particular classification or categorization can be supplied by the user according to what their particular needs may be.

The AI processor 150 utilizes an algorithm to use the multiple data points retrieved in conjunction with each monetary data transaction to categorize or classify each monetary data transaction. User input may also be used as a data point. With the information, the AI processor 150 and the core engine 200 are able to classify or categorize each data transaction. In addition, the AI processor 150 and the core engine 200 determine and assign a confidence level to each classification or categorization.

In some embodiments, the core engine 200 is configured to assign a confidence level between 0% and 100% which indicates how certain the AI processor 150 is with the determined classification or categorization. A confidence level is associated with each classification that is assigned. In some embodiments, the AI processor 150 and the core engine 200 may determine that based on the location and time of the monetary data transaction, that the expense qualifies as a particular business expense and can be classified on a schedule C or other tax document. This is just an example of the classification that is possible. The AI processor and core engine determine and assign a confidence level to the determination.

In some embodiments, the AI processor 150 and the core engine 200 may determine a backup or secondary classification or categorization that may be possible for the monetary data transaction. The backup or secondary classification may also be assigned a confidence level. Just for purposes of an example, the AI processor and core engine may determine that an expense is an asset to be depreciated and may assign a confidence level of 80% and may determine that the expense may alternatively be an ordinary expense and may assign a confidence level of 15% to this secondary classification.

The confidence level is a numerical indication of how confident the AI processor and the core engine are that the category or classification is correct. This confidence level may be associated with the data points that are collected as well as past user input. The AI processor and core engine can learn to better classify expenses or income (or other monetary data transaction) over time as the algorithm is updated and learns to better categorize the data.

In some embodiments, the confidence level is determined by various factors that either input into the AI processor or used by the AI processor. Such factors may include, but are not limited to, a date range, business or vendor type, NAICS classification code, location of business operations, and the desired output format.

Although described generally as an AI processor, the AI processor may be a general neural network with back propagation via reinforced learning with human feedback. In some embodiments, an AI transformer architecture may be used to help establish attention and/or context for each transaction. The particular algorithm used to effectuate the processes discussed herein may use machine learning or other types of iterative processes to learn and propagate learning through the algorithm or the neural network such that neural network may continue to learn and update as needed and may become more confident in classification and categorization.

The core engine 200 may be configured to then output each data transaction with an associated category or classification into an output database 270. In some embodiments, the core engine 200 is configured to communicate with a validation terminal or validation user interface (UI) 190. The validation UI may allow a user to validate, reject, or edit the classification or category for some or all of the data transactions. In some embodiments, the validation UI 190 in association with the core engine 200 may flag all data transactions or some data transactions that have a confidence level below a certain threshold. As an example, the core engine 200 may be configured to output all data transactions with a confidence level above 90% and to send all data transactions with confidence level below 90% to the validation UI 190. The user then can review each data transaction below the threshold to determine if the AI processor and core engine determined the correct category. The information input by the user at the validation UI 190 may then be used to better classify future data transactions as the AI processor and core engine learn which transactions were validated and which transactions were edited.

The foregoing discussion is a general discussion of many of the processes present in some embodiments of the invention and the discussion is for illustrative purposes. Other embodiments may include variations of these processes.

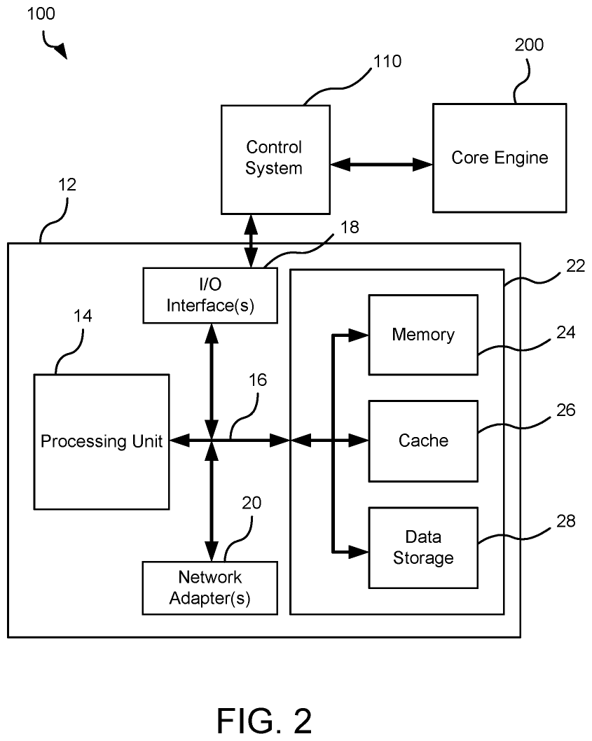

Referring now to FIG. 2, a schematic diagram of a computing system 100 is shown. Although the computing system 100 is shown and described with certain components and functionality, other embodiments of the computing system 100 may include fewer or more components to implement less or more functionality.

In some embodiments, aspects of the computing system 100 are implemented via a networked system or a computer system 12 or its component parts. The illustrated computer system 12 may include, but is not limited to, one or more processing arrangements, for example including processors or processing units 14, a communication bus 16, one or more input/output (I/O) adapters 18, one or more network adapters 20, and a system memory 22.

In one embodiment, the system memory 22 includes computer system readable media in the form of volatile memory, such as random-access memory (RAM) 24 and/or cache memory 26. The system memory 22 may further include other removable/non-removable, volatile/non-volatile computer system storage media 28. In such instances, each can be connected to the bus 16 by one or more data media interfaces. The memory 22 may include at least one program product having a set (e.g., at least one) of program modules that are configured to carry out the functions of proposed embodiments. For instance, the memory 22 may include a computer program product having program executable by the processing unit 14 to perform processes described herein. Programs and/or utilities having a set (at least one) of program modules may be stored in the memory 22. Program modules generally carry out the functions and/or methodologies described herein.

The computer system 12 may also communicate with one or more external devices such as a keyboard, a display, sensors 122, cameras, apps, or other external devices, including but not limited to a control system 110. Also, the computer system 12 can communicate with one or more networks such as a local area network (LAN), a general wide area network (WAN), and/or a public network (e.g., the Internet) via network adapter 20.

In the context of the present application, where embodiments of the present invention constitute a method, it should be understood that such a method is a process for execution by a computer, i.e. is a computer-implementable method. The steps of the method therefore reflect various parts of a computer program, e.g., parts of one or more algorithms. Embodiments of the present invention may be a system, a method, and/or a computer program product. The computer program product may include a computer readable storage medium (or media) having computer readable program instructions thereon for causing a processor to carry out aspects of the present invention.

Referring to FIG. 2 again, the control system 110 interacts with and receives communication with the core engine 200. The control system 110 is further configured to control the system 100 and its function as the core engine communicates with the various components outlined in conjunction with FIG. 1. In some embodiments, more than one control system 110 may control the various components of the system 102 or the general system 100.

The system 102 or general system 100 may be utilized to implement a computer-implemented method. In some embodiments, the computer-implemented method includes retrieving payment transaction data from a banking transaction database, wherein the payment transaction data comprises a plurality of payment transactions, utilizing an AI processor to categorize each payment transaction of the plurality of payment transactions into a category, and utilizing the AI processor to assign a confidence level to each payment transaction. The confidence level is at or between zero percent and one hundred percent.

In some embodiments, the computer-implemented method further includes requesting a validation from a user to validate the category of each transaction. In some embodiments, the computer-implemented method further includes utilizing validation data to update a confidence level algorithm utilized by the AI processor. In some embodiments, the confidence level algorithm may be the neural network that has been retrained through back propagation of the information that has been validated or edited.

In some embodiments, the computer-implemented method further includes requesting a validation from a user to validate the category of each transaction with a confidence level below a predetermined threshold. In some embodiments, there is no threshold and the user can use the confidence level percentage as a general guide to better know what level of review is needed or not needed.

In some embodiments, the computer-implemented method further includes outputting payment transactions segregated into categories in an income statement based on the validation from the user. In some embodiments, the output may be a schedule C tax form. In some embodiments, the output may be a form 1065 for a partnership tax return. In some embodiments, the output may be a form 1120. In some embodiments, the output may be a form 1120S

In other embodiments, the output may not be tax related as the output may be an accounting document such as a financial statement or financial reporting. In some embodiments, the output may be a general accounting document such as an income statement and/or balance sheet in conformity with Generally Accepted Accounting Principles (GAAP) or any other hybrid accounting financial presentation. Accurately categorizing the data may be necessary for tax reasons, accounting reasons, or merely for general budgeting reasons. The categories that are determined will be based on what output is desired by the user.

As an example, if a user was in need of a schedule C output document, the categories would be determined by those found on a schedule C. Some of the categories might be, in this example, advertising, car and truck expenses, commissions and fees, insurance, legal and professional services, etc. This is an example for illustrative purposes.

As another example, if a user was in need of an income statement for financial reporting, the categories may be determined GAAP guidelines or other accounting guidelines. Some of the categories might be, in this example, salaries and wages, office expenses, rent, travel expenses, advertising expenses, etc. This is an example for illustrative purposes.

In some embodiments, the computer-implemented method further includes receiving banking access credentials and logging into the banking transaction database.

In some embodiments, the computer-implemented method further includes utilizing a categorization algorithm to categorize the transaction, wherein the categorization algorithm utilizes one or more inputs including description of the transaction, time of the transaction, monetary amount of the transaction, location of the transaction, or vendor of the transaction.

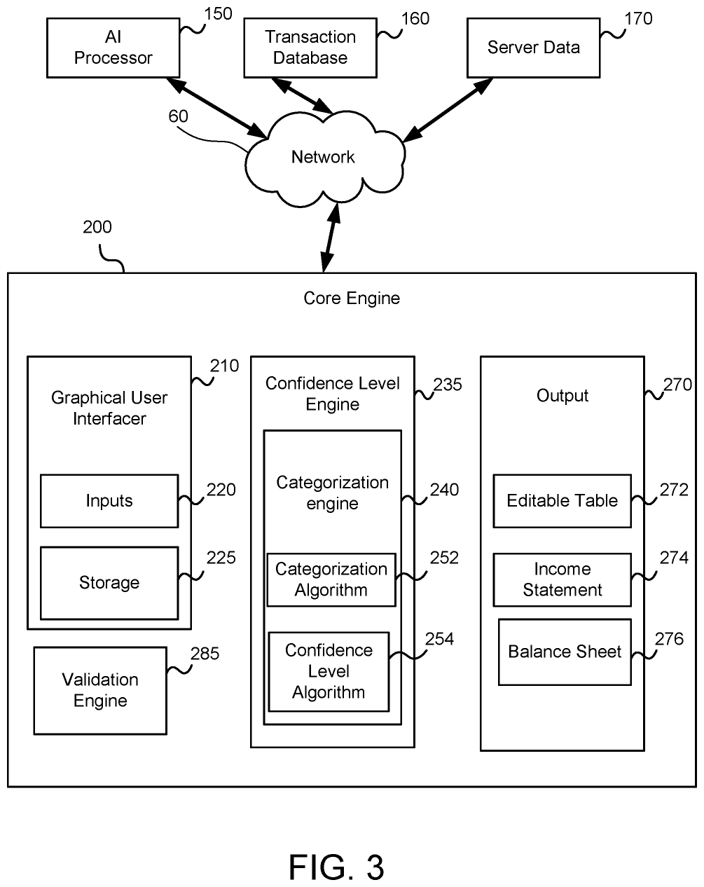

Referring now to FIG. 3, a schematic diagram of a categorization system is shown, according to one or more embodiments of the invention, with a more detailed description of the core engine 200. As is shown, the categorization system includes a network 60 that allows for the core engine 200 to communicate with a general transaction database 160 (similar to the banking database of FIG. 1), an AI processor 150, and a server or server data 170. The server data 170 may include information input by the user or information associated with the individual transactions on the transaction database 160.

In the illustrated embodiment, the core engine 200 includes various components that may implement many of the processes discussed previously in FIGS. 1 and 2 and the other description found throughout this application. The core engine 200 may include a graphical user interface (GUI) 210. The GUI 210 may include functionality to allow a user to provide inputs 220 to the core engine 200. Such inputs may be stored within the core engine in storage 225 or may be stored in an external database or storage or may be stored as is discussed with computer system 12 of FIG. 2.

The core engine 200 may also comprise sub-engines that are capable of implementing some of the processes and steps that are discussed herein. In the illustrated embodiments, the core engine 200 includes a confidence level engine 235. The confidence level engine 235 may be able to determine the confidence level as discussed herein. As part of the confidence level engine 235, the core engine 200 may include a categorization engine 240. The categorization engine 240 is configured to determine the category or classification of the data transaction. The categorization engine 240 may use a categorization algorithm 252 or may interact partially or wholly with the AI processor 150 through network 60. In some embodiments, the categorization algorithm 252 is separate from the AI processor 150. In addition, some embodiments may include a confidence level algorithm 254. The confidence level algorithm 254 may help the confidence level engine 235 determine the particular confidence level assigned to a data transaction. Similar to what was described with the categorization algorithm 252, the confidence level algorithm 254 may be used by the core engine 200 or may interact partially or wholly with the AI processor 150 though the network. In some embodiments, the confidence level algorithm 254 is separate from the AI processor 150.

The core engine 200 is also able to determine an output 270 or output document. The output document may be editable table 272, an income statement 274, or a balance sheet 276. These are examples of outputs that are possible. Many other types of output documents have been discussed herein and are not repeated only for the sake of brevity.

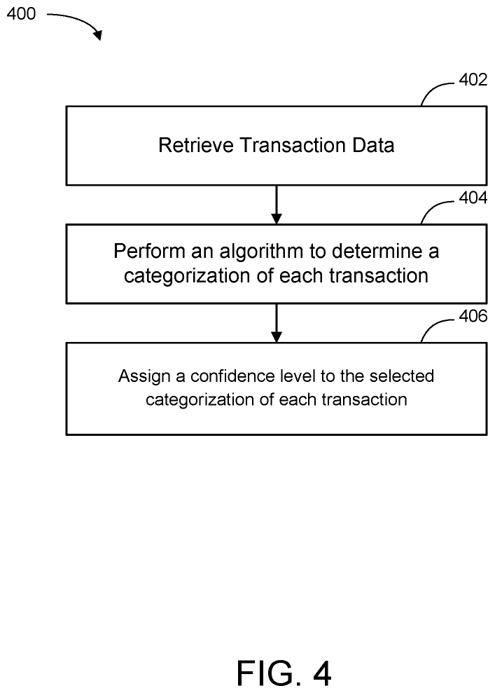

Referring now to FIG. 4, a schematic flow diagram of a method, according to one or more embodiments of the invention, is shown. The method 400 is a general method. The method 400 includes various steps. More or less steps may be used in other embodiments. At block 402, the method 400 includes retrieving transaction data. This data may be retrieved from transaction database or a banking database or other similar database. At block 404, the method 400 includes performing an algorithm to determine a categorization of each transaction. Such categorization may be effectuated by communicated and prompting an AI processor or neural network to categorize the transactions according to a desired output. Examples of outputs are discussed throughout. At block 406, the method 400 includes assigning a confidence level to the selected categorization of each transaction. As discussed before the confidence level is how confident the system is that the category is the correct category for the transaction. The method 400 then ends.

In some embodiments, the method is a computer-implemented method. In some embodiments, the computer-implemented method includes retrieving payment transaction data from a banking transaction database, wherein the payment transaction data comprises a plurality of payment transactions, utilizing an AI processor to categorize each payment transaction of the plurality of payment transactions into a category, and utilizing the AI processor to assign a confidence level to each payment transaction. The confidence level is at or between zero percent and one hundred percent.

In some embodiments, the computer-implemented method further includes requesting a validation from a user to validate the category of each transaction. In some embodiments, the computer-implemented method further includes utilizing validation data to update a confidence level algorithm utilized by the AI processor. In some embodiments, the confidence level algorithm may be the neural network that has been retrained through back propagation of the information that has been validated or edited.

In some embodiments, the computer-implemented method further includes requesting a validation from a user to validate the category of each transaction with a confidence level below a predetermined threshold. In some embodiments, there is no threshold and the user can use the confidence level percentage as a general guide to better know what level of review is needed or not needed.

In some embodiments, the computer-implemented method further includes receiving banking access credentials and logging into the banking transaction database.

In some embodiments, the computer-implemented method further includes utilizing a categorization algorithm to categorize the transaction, wherein the categorization algorithm utilizes one or more inputs including description of the transaction, time of the transaction, monetary amount of the transaction, location of the transaction, or vendor of the transaction.

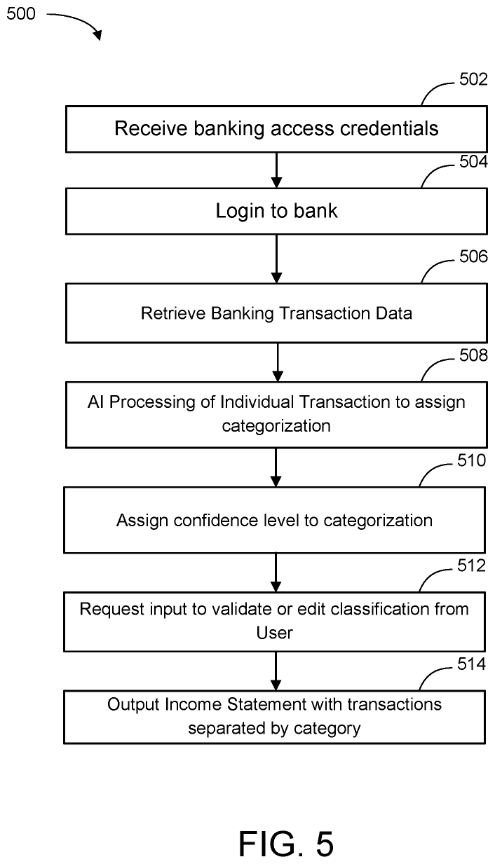

FIG. 5 depicts a schematic flow diagram of a method, according to one or more embodiments of the invention. The method 500 includes various steps. More or less steps may be used in other embodiments. At block 502, the method 500 includes receiving banking access credentials. Such banking access credentials will allow the system to access a banking database. At block 504, the method 500 includes logging into the bank associated with the banking access credentials. Such access may be over the internet and into a general internet banking platform. At block 506, the method 500 includes retrieving banking transaction data. The banking transaction data may include various data including the monetary transaction total, description of the transaction, time of the transaction, location of the transaction, or vendor of the transaction. At block 508, the method 500 includes processing through AI each transaction to assign a categorization according to a prompt given to an AI processor. The categorization will be based on the desired output needed for the user. At block 510, the method 500 includes assigning a confidence level to the categorization that occurs at block 508. The confidence level is determined wholly or partially by the AI processor in some embodiments. At block 512, the method 500 includes requesting input from a user to validate or edit the classification. Other types of validation information can be prompted to a user. At block 514, the method 500 includes outputting an output document for the user with the transactions separated by category. The type of output document will be determined by what is needed by the user but may include a tax document, an accounting document, or a budgeting document in which transactions need to be categorized. The method 500 then ends.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

Reference throughout this specification to features, advantages, or similar language does not imply that all of the features and advantages that may be realized with the subject matter of the present disclosure should be or are in any single embodiment. Rather, language referring to the features and advantages is understood to mean that a specific feature, advantage, or characteristic described in connection with an embodiment is included in at least one embodiment of the present disclosure. Thus, discussion of the features and advantages, and similar language, throughout this specification may, but do not necessarily, refer to the same embodiment.

In the above description, specific details of various embodiments are provided. However, some embodiments may be practiced with less than all of these specific details. In other instances, certain methods, procedures, components, structures, and/or functions are described in no more detail than to enable the various embodiments of the invention, for the sake of brevity and clarity.

Although the operations of the method(s) herein are shown and described in a particular order, the order of the operations of each method may be altered so that certain operations may be performed in an inverse order or so that certain operations may be performed, at least in part, concurrently with other operations. In another embodiment, instructions or sub-operations of distinct operations may be implemented in an intermittent and/or alternating manner.

Although specific embodiments of the invention have been described and illustrated, the invention is not to be limited to the specific forms or arrangements of parts so described and illustrated. The scope of the invention is to be defined by the claims appended hereto and their equivalents.

As used herein, the phrase “at least one of”, when used with a list of items, means different combinations of one or more of the listed items may be used and only one of the items in the list may be needed. The item may be a particular object, thing, or category. In other words, “at least one of” means any combination of items or number of items may be used from the list, but not all of the items in the list may be required. For example, “at least one of item A, item B, and item C” may mean item A; item A and item B; item B; item A, item B, and item C; or item B and item C. In some cases, “at least one of item A, item B, and item C” may mean, for example, without limitation, two of item A, one of item B, and ten of item C; four of item B and seven of item C; or some other suitable combination.

As used herein, a system, apparatus, structure, article, element, component, or hardware “configured to” perform a specified function is indeed capable of performing the specified function without any alteration, rather than merely having potential to perform the specified function after further modification. In other words, the system, apparatus, structure, article, element, component, or hardware “configured to” perform a specified function is specifically selected, created, implemented, utilized, programmed, and/or designed for the purpose of performing the specified function. As used herein, “configured to” denotes existing characteristics of a system, apparatus, structure, article, element, component, or hardware which enable the system, apparatus, structure, article, element, component, or hardware to perform the specified function without further modification. For purposes of this disclosure, a system, apparatus, structure, article, element, component, or hardware described as being “configured to” perform a particular function may additionally or alternatively be described as being “adapted to” and/or as being “operative to” perform that function.

Although specific embodiments of the invention have been described and illustrated, the invention is not to be limited to the specific forms or arrangements of parts so described and illustrated. The scope of the invention is to be defined by the claims appended hereto and their equivalents.

What is claimed is:

1. A computer-implemented method comprising:
retrieving payment transaction data from a banking transaction database, wherein the payment transaction data comprises a plurality of payment transactions;
utilizing an AI processor to categorize each payment transaction of the plurality of payment transactions into a category; and
utilizing an AI processor to assign a confidence level to each payment transaction, wherein the confidence level is at or between zero percent and one hundred percent.

2. The computer-implemented method of claim 1, further comprising requesting a validation from a user to validate the category of at least one transaction.

3. The computer-implemented method of claim 2, further comprising utilizing validation data to update a confidence level algorithm utilized by the AI processor.

4. The computer-implemented method of claim 1, further comprising requesting a validation from a user to validate the category of each transaction with a confidence level below a predetermined threshold.

5. The computer-implemented method of claim 4, further comprising outputting payment transactions segregated into categories in an output document based on the validation from the user.

6. The computer-implemented method of claim 5, further comprising receiving banking access credentials and logging into the banking transaction database.

7. The computer-implemented method of claim 6, further comprising utilizing a categorization algorithm to categorize the transaction, wherein the categorization algorithm utilizes one or more inputs including description of the transaction, time of the transaction, monetary amount of the transaction, location of the transaction, or vendor of the transaction.

8. A computer system, comprising:
one or more processors;
memory including instructions which, when accessed by the one or more processors, cause the one or more processors to:
retrieve payment transaction data from a banking transaction database, wherein the payment transaction data comprises a plurality of payment transactions;
utilize an AI processor to categorize each payment transaction of the plurality of payment transactions into a category; and
utilize an AI processor to assign a confidence level to each payment transaction, wherein the confidence level is at or between zero percent and one hundred percent.

9. The computer system of claim 8, wherein the memory includes further instructions which cause the one or more processors to: request a validation from a user to validate the category of at least one transaction.

10. The computer system of claim 9, wherein the memory includes further instructions which cause the one or more processors to: utilize validation data to update a confidence level algorithm utilized by the AI processor.

11. The computer system of claim 8, wherein the memory includes further instructions which cause the one or more processors to: request a validation from a user to validate the category of each transaction with a confidence level below a predetermined threshold.

12. The computer system of claim 11, wherein the memory includes further instructions which cause the one or more processors to: output payment transactions segregated into categories in an output document based on the validation from the user.

13. The computer system of claim 12, wherein the memory includes further instructions which cause the one or more processors to: receive banking access credentials and logging into the banking transaction database.

14. The computer system of claim 13, wherein the memory includes further instructions which cause the one or more processors to: utilize a categorization algorithm to categorize the transaction, wherein the categorization algorithm utilizes one or more inputs including description of the transaction, time of the transaction, monetary amount of the transaction, location of the transaction, or vendor of the transaction.

15. A computer system comprising:
a core engine comprising one or more processors and configured to retrieve payment transaction data from a banking transaction database, wherein the payment transaction data comprises a plurality of payment transactions;
a categorization engine comprising one or more processors and configured utilize an AI processor to categorize each payment transaction of the plurality of payment transactions into a category; and
a confidence level engine comprising one or more processors and configured to utilize an AI processor to assign a confidence level to each payment transaction, wherein the confidence level is at or between zero percent and one hundred percent.

16. The computer system of claim 15, further comprising a validation engine comprising one or more processors and configured to request a validation from a user to validate the category of at least one transaction.

17. The computer system of claim 16, wherein the validation engine is configured to utilize validation data to update a confidence level algorithm utilized by the AI processor.

18. The computer system of claim 15, further comprising a validation engine comprising one or more processors and configured to request a validation from a user to validate the category of each transaction with a confidence level below a predetermined threshold.

19. The computer system of claim 18, wherein the core engine is configured to output payment transactions segregated into categories in an output document based on the validation from the user.

20. The computer system of claim 19, wherein the core engine is configured to receive banking access credentials and log into the banking transaction database.
